(19) United States
(12) Patent Application Publication
(10) Pub. No.: US 2026/0010252 A1
(43) Pub. Date: Jan. 8, 2026

(54) DISPLAY DEVICE, DRIVING METHOD THEREOF, AND ELECTRONIC DEVICE

(71) Applicant: Samsung Display Co., Ltd., Yongin-si (KR)

(72) Inventors: Kyoung Hun BEEN, Yongin-si (KR); Byeong Kyu JEON, Yongin-si (KR)

(21) Appl. No.: 19/258,290

(22) Filed: Jul. 2, 2025

(30) Foreign Application Priority Data
Jul. 2, 2024 (KR) 10-2024-0086859

(51) Int. Cl. G06F 3/041; G06F 3/044

(52) U.S. Cl. CPC G06F 3/04162; G06F 3/0441; G06F 3/0442

(57) ABSTRACT

One or more embodiments provide a display device, a driving method of a display device, and an electronic device, the driving method including receiving position information of a pen adjacent to the touch panel, calculating a plurality of position coordinates of the pen, determining whether a drawing line connecting the plurality of position coordinates corresponds to a curved line based on the plurality of position coordinates of the pen, driving in a curved line mode when the drawing line corresponds to the curved line, or driving in a straight line mode when the drawing line does not correspond to the curved line, and changing a report rate value of the touch panel by considering a drawing speed of the pen in the curved line mode.

### CROSS-REFERENCE TO RELATED APPLICATION

The present application claims priority to, and the benefit of, Korean Patent Application No. 10-2024-0086859, filed on Jul. 2, 2024, in the Korean Intellectual Property Office, the entire disclosure of which is incorporated herein by reference.

### BACKGROUND

### 1. Field

The present disclosure relates to a display device, a driving method thereof and electronic device including the same.

### 2. Description of the Related Art

Recently, display devices provided with a touch panel that may allow a user to input a touch on a screen using a finger or pen, and that may recognize and output the touch, are widely used. Such display devices that receive input information by touching the screen may include a touch driver that receives a signal from the touch panel and that detects the presence or absence of a touch input and touch coordinates corresponding to a touch position.

However, when a user performs touch drawing on the screen using a finger or pen, noise may be included in the touch input due to unintended hand tremors or other external factors, and thus, the result of the touch drawing may not be derived as intended by the user.

The above information disclosed in this Background section is only for enhancement of understanding of the background of the present disclosure, and, therefore, it may contain information that does not form the prior art that is already known to a person of ordinary skill in the art.

### SUMMARY

Embodiments of the present disclosure attempt to provide a display device and a driving method thereof that may improve the quality of touch drawing. One or more embodiments provides a driving method of a display device

including a touch panel, the driving method including receiving position information of a pen adjacent to the touch panel, calculating a plurality of position coordinates of the pen, determining whether a drawing line connecting the plurality of position coordinates corresponds to a curved line based on the plurality of position coordinates of the pen, driving in a curved line mode when the drawing line corresponds to the curved line, or driving in a straight line mode when the drawing line does not correspond to the curved line, and changing a report rate value of the touch panel by considering a drawing speed of the pen in the curved line mode.

The driving method may further include increasing the report rate value as the drawing speed of the pen increases in the curved line mode.

The report rate value in the straight line mode may be greater than the report rate value in the curved line mode for the same drawing speed.

As the report rate value decreases, a ratio of a number of the plurality of position coordinates calculated to a number of the position information received may decrease.

The driving method may further include fixing the report rate value to an initial set value in the driving in the straight line mode.

The determining whether the drawing line corresponds to the curved line may include calculating a plurality of inclination values between the plurality of position coordinates of the pen, and determining whether the drawing line corresponds to the curved line by using an amount of change in the plurality of inclination values.

The driving method may further include receiving, at the display device, from the pen, a downlink signal including the position information and at least one of inclination information of the pen and touch pressure information of the pen.

One or more other embodiments provides a driving method of a display device including a touch panel, the driving method including receiving position information of a pen adjacent to the touch panel, calculating a plurality of position coordinates of the pen, determining whether a drawing line connecting the plurality of position coordinates corresponds to a curved line based on the plurality of position coordinates of the pen, driving in a curved line mode when the drawing line corresponds to the curved line, or driving in a straight line mode when the drawing line does not correspond to the curved line, and changing a report rate value of the pen by considering a drawing speed of the pen in the curved line mode.

The driving in the curved line mode may include transmitting, by the display device, an uplink signal including a report-rate-setting value to the pen, and changing the report rate value of the pen to the report-rate-setting value.

The driving method may further include increasing the report rate value of the pen as the drawing speed of the pen increases in the driving in the curved line mode.

The report rate value in the straight line mode may be greater than the report rate value in the curved line mode for the same drawing speed.

The driving method may further include decreasing a number of the position information received from the pen as the report rate value of the pen decreases.

The driving method may further include fixing the report rate value of the pen to an initial set value in the driving in the straight line mode.

The determining whether the drawing line corresponds to the curved line may include calculating a plurality of inclination values between the plurality of position coordinates of the pen, and determining whether the drawing line corresponds to the curved line by using an amount of change in the plurality of inclination values.

The driving method may further include receiving, at the display device, from the pen, a downlink signal including the position information, and at least one of inclination information of the pen and touch pressure information of the pen.

One or more other embodiments provides a display device including a touch panel including touch electrodes, and a touch driver configured to receive position information of a pen adjacent to the touch panel, calculate a plurality of position coordinates of the pen, determine whether a drawing line connecting the plurality of position coordinates corresponds to a curved line based on the plurality of position coordinates of the pen, drive in a curved line mode when the drawing line corresponds to the curved line, or drive in a straight line mode when the drawing line does not correspond to the curved line, and change a report rate value of the touch panel by considering a drawing speed of the pen in the curved line mode.

The report rate value may be configured to increase as the drawing speed of the pen increases in the curved line mode.

The report rate value in the straight line mode may be greater than the report rate value in the curved line mode for the same drawing speed.

A ratio of a number of the plurality of position coordinates calculated to a number of the position information received may be configured to decrease as the report rate value decreases.

The report rate value may be configured to be fixed to an initial set value in the straight line mode.

One or more other embodiments provides an electronic device including a display device including a touch panel including touch electrodes, and a touch driver configured to receive position information of a pen adjacent to the touch panel, calculate a plurality of position coordinates of the pen, determine whether a drawing line connecting the plurality of position coordinates corresponds to a curved line based on the plurality of position coordinates of the pen, drive in a curved line mode when the drawing line corresponds to the curved line, or drive in a straight line mode when the drawing line does not correspond to the curved line, and change a report rate value of the touch panel by considering a drawing speed of the pen in the curved line mode.

The electronic device may include a smartphone, a television, a monitor, a tablet (or a tablet personal computer (PC)), an electric vehicle, a mobile phone, a mobile communication terminal, an electronic notebook, an electronic book, a portable multimedia player (PMP), a navigation device, an ultra-mobile PC (UMPC), a laptop computer, a billboard, an Internet of Things (IoT) device, a smartwatch, a watch phone, or a head-mounted display (HMD).

According to the display device and the driving method thereof according to the embodiments of the present disclosure, it is possible to improve the quality of touch drawing.

Aspects of the embodiments of the present disclosure are not limited by what is illustrated in the above, and more various aspects are included in the present specification.

### BRIEF DESCRIPTION OF THE DRAWINGS

FIG. 1 illustrates a block diagram of a display device according to one or more embodiments of the present disclosure.

FIG. 2 illustrates a block diagram of one or more embodiments of a touch panel of FIG. 1.

FIG. 3 illustrates a block diagram of one or more embodiments of a display driver and a display panel of FIG. 1.

FIG. 4 illustrates a block diagram of an uplink process according to embodiments.

FIG. 5 illustrates a block diagram of a downlink process according to embodiments.

FIG. 6 is a drawing for explaining uplink signals and downlink signals.

FIG. 7 illustrates a flowchart of a driving method of the display device of FIG. 1 according to embodiments.

FIG. 8 illustrates a flowchart of operation S300 of FIG. 7 according to one or more embodiments.

FIG. 9 illustrates a flowchart of operation S300 of FIG. 7 according to one or more other embodiments.

FIG. 10A and FIG. 10B are drawings for explaining operation S200 of FIG. 7.

FIG. 11A and FIG. 11B are drawings for explaining aspects of a display device according to embodiments.

FIG. 12 is a block diagram of an electronic device according to an embodiment.

FIG. 13 shows schematic views of various embodiments of an electronic device.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Additionally, the use of cross- hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to one or more sectional illustrations that are schematic illustrations of embodiments and/or intermediate structures. As such, variations from the shapes of the illustrations as a result of, for example, manufacturing techniques and/or tolerances, are to be expected.

Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling to another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” and “at least one selected from the group consisting of X, Y, and Z,” may be construed as X only, Y only, Z only, any combination of two or more of X, Y, and Z, such as, for instance, XYZ, XY, YZ, and XZ, or any variation thereof. Similarly, the expressions “at least one of A and B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, a first component, a first region, a first layer or a first section described below could be termed a second element, a second component, a second region, a second layer or a second section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for the first direction DR1, the second direction DR2, and/or the third direction.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of ±5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, ±20%, ±10%, or ±5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

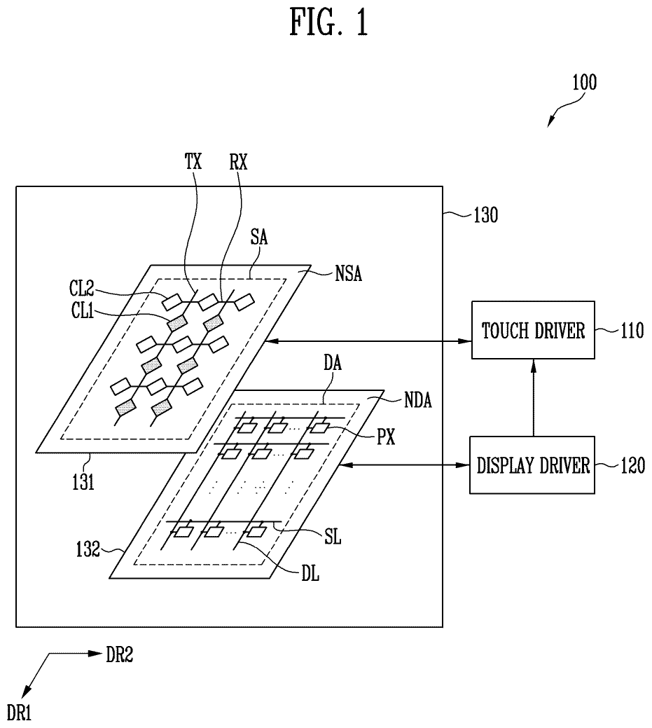

FIG. 1 illustrates a block diagram of a display device according to one or more embodiments of the present disclosure.

Referring to FIG. 1, a display device 100 may include a touch driver 110, a display driver 120, and a panel 130.

The panel 130 may include a display panel 132, and a touch panel 131 overlapping the display panel 132.

In embodiments, the display panel 132 and the touch panel 131 may be manufactured separately from each other, and then may be coupled to at least partially overlap each other. In other embodiments, the display panel 132 and the touch panel 131 may be integrally manufactured. In this case, the touch panel 131 may be directly formed on at least one layer configuring the display panel 132, for example, an upper substrate of the display panel 132, a thin film encapsulation layer, or an insulating layer.

In FIG. 1, it is shown that the touch panel 131 is located on the display panel 132, but the touch panel 131 is not limited thereto. For example, the touch panel 131 may be located under the display panel 132.

The display panel 132 may include a display area DA for displaying an image, and a non-display area NDA around the display area DA. The non-display area NDA may at least partially surround the display area DA (e.g., in plan view). The display panel 132 may include pixels PX formed on a substrate. The pixels PX may be located in the display area DA. In embodiments, the substrate may be a rigid substrate including a material, such as glass or tempered glass. In other embodiments, the substrate may be a flexible substrate including a material, such as plastic or metal.

The pixels PX are connected to scan lines SL and data lines DL. The pixels PX are selected by a turn-on level driving signal supplied through the scan lines SL, and may receive data signals through the data lines DL. Accordingly, pixels PX emit light with luminances corresponding to the data signals, and an image is displayed in the display area DA.

In the non-display area NDA, wires and/or an internal circuit connected to the pixels PX may be arranged. For example, a scan driver may be further located in the non-display area NDA.

In embodiments, the display panel 132 may include pixels PX including such as organic light-emitting diodes, inorganic light-emitting diodes, and quantum dot/well light-emitting diodes. In other embodiments, the display panel 132 may be implemented as a liquid crystal display panel. In this case, the display device 100 may additionally include a light source, such as a backlight unit.

The touch panel 131 may include an active area SA capable of sensing a touch, and a non-active area NSA around the active area SA. The active area SA may at least partially overlap the display area DA.

The touch panel 131 may include a substrate and driving electrodes TX and sensing electrodes RX formed on the substrate. The driving electrodes TX may include first cells CL1. The sensing electrodes RX may include second cells CL2. The driving electrodes TX and the sensing electrodes RX may be located in the active area SA on the substrate. In embodiments, the substrate may be a rigid substrate including a material, such as glass or tempered glass. In other embodiments, the substrate may be a flexible substrate including a material, such as plastic or metal. In embodiments, at least one layer configuring the display panel 132 may be used as a substrate for the touch panel 131.

In embodiments, the display driver 120 and the touch driver 110 may be configured as integrated chips (IC) separate from each other. In other embodiments, the display driver 120 and the touch driver 110 may be mounted within a single IC.

The display driver 120 is electrically connected to the display panel 132 to drive the pixels PX. For example, the display driver 120 may include a data driver connected to the data lines DL, a scan driver connected to the scan lines SL, and a timing controller that controls the data driver and the scan driver. As another example, the display driver 120 may include a data driver and a timing controller, and a scan driver may be located in the non-display area NDA of the display panel 132.

The touch driver 110 may be connected to the touch panel 131 to drive the touch panel 131 using a driving signal.

The display driver 120 may display an image in the display panel 132 in units of display frames. The touch driver 110 may detect a touch in units of sensing frames. The sensing frame period and the display frame period may be synchronized, or may not be synchronized.

The display device 100 according to one or more embodiments is a device that displays a moving image and/or a still image. The display device 100 may be applied to portable electronic devices such as mobile phones, smartphones, tablet personal computers (PCs), mobile communication terminals, electronic notebooks, electronic books, portable multimedia players (PMPs), navigation devices, and ultra-mobile PCs (UMPCs). For example, the display device 100 may be applied to a display unit of a television, a laptop computer, a monitor, a billboard, or the Internet of Things (IoT) device. Alternatively, in one or more embodiments, the display device 100 may be applied to a smartwatch, a watch phone, and/or a head-mounted display (HMD) for implementing virtual reality and/or augmented reality.

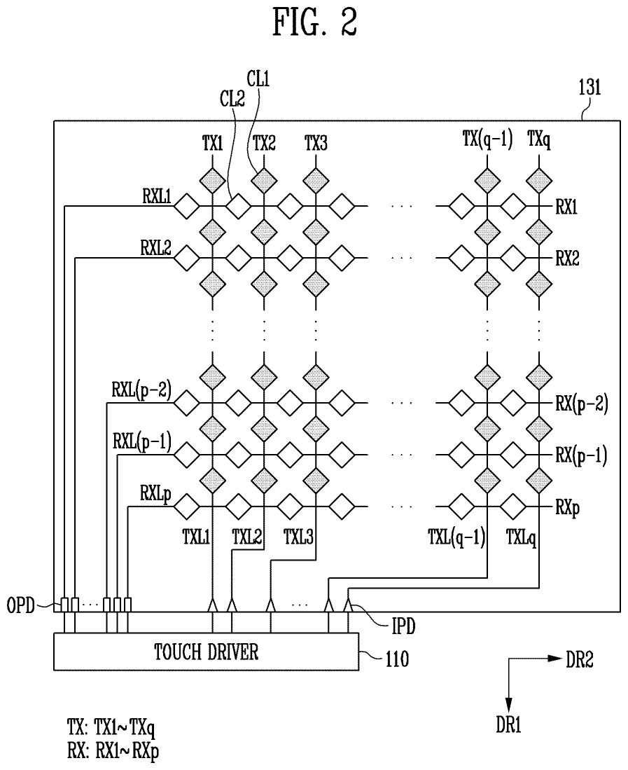

FIG. 2 illustrates a block diagram of one or more embodiments of a touch panel of FIG. 1.

Referring to FIG. 2, the touch panel 131 may include first to q-th driving electrodes TX1 to TXq and first to p-th sensing electrodes RX1 to RXp. The first to q-th driving electrodes TX1 to TXq may be connected to first to q-th driving lines TXL1 to TXLq, respectively. The first to p-th sensing electrodes RX1 to RXp may be connected to first to p-th sensing lines RXL1 to RXLp, respectively.

Each of the first to q-th driving electrodes TX1 to TXq may include first cells CL1 arranged in the first direction DR1 and electrically connected to each other, and each of the first to p-th sensing electrodes RX1 to RXp may include second cells CL2 arranged in the second direction DR2 and electrically connected to each other. In FIG. 2, each of the first cells CL1 and the second cells CL2 is illustrated as having a diamond shape. However, embodiments are not limited thereto. For example, each of the first cells CL1 and the second cells CL2 may have at least one of various shapes, such as a circular shape, a quadrangular shape other than the diamond shape, a triangular shape, and/or a mesh shape. In addition, the first cells CL1 and the second cells CL2 may be formed of a single layer or multiple layers. As described above, shapes and arrangements of the first to q-th driving electrodes TX1 to TXq and the first to p-th sensing electrodes RX1 to RXp may be variously modified.

In embodiments, the first cells CL1 and the second cells CL2 may be conductive by including at least one of various conductive materials, such as a metal material, a transparent conductive material, and/or the like. For example, the first cells CL1 and the second cells CL2 may include at least one of various metallic materials, such as gold (Au), silver (Ag), aluminum (Al), molybdenum (Mo), chromium (Cr), titanium (Ti), nickel (Ni), neodymium (Nd), copper (Cu), or platinum (Pt), or an alloy thereof.

The touch panel 131 may further include input pads IPD connected to the first to q-th driving lines TXL1 to TXLq. The touch driver 110 of FIG. 1 may be connected to the first to q-th driving lines TXL1 to TXLq through the input pads IPD.

The touch panel 131 may further include output pads OPD connected to the first to p-th sensing lines RXL1 to RXLp. The touch driver 110 may be connected to the first to p-th sensing lines RXL1 to RXLp through the output pads OPD.

Generally, when a user's touch is provided to the touch panel 131, the principle by which the display device 100 recognizes the touch may be as follows.

The touch panel 131 may include first touch electrodes and second touch electrodes that form mutual capacitances with the first touch electrodes. The first touch electrodes may be provided as the first driving electrode TX1, the second driving electrode TX2, the third driving electrode TX3, . . . , the q-1-th driving electrode TX(q-1), and the q-th driving electrode TXq (q is a positive integer). The second touch electrodes may be provided as the first sensing electrode RX1, the second sensing electrode RX2, . . . , the p-2-th sensing electrode RX(p-2), the p-1-th sensing electrode RX(p-1), and the p-th sensing electrode RXp (p is a positive integer). The first to q-th driving electrodes TX1 to TXq may extend in the first direction DR1, and may be spaced apart from each other in the second direction DR2. The first to p-th sensing electrodes RX1 to RXp may extend in the second direction DR2, and may be spaced apart from each other in the first direction DR1. The first to p-th sensing electrodes RX1 to RXp may cross the first to q-th driving electrodes TX1 to TXq, and may be electrically separated from each other to form mutual capacitance with the first to q-th driving electrodes TX1 to TXq.

When a user's touch is provided to the touch panel 131, one or more of the mutual capacitances may change. For example, a touch may include at least one of various types of inputs that cause a change in mutual capacitance, such as a user's physical contact or hovering. The touch driver 110 may detect such a change in mutual capacitance and recognize a touch.

The touch driver 110 is connected to the first to q-th driving electrodes TX1 to TXq through the first driving line TXL1, the second driving line TXL2, the third driving line TXL3, . . . , the q-1-th driving line TXL(q-1), and the q-th driving line TXLq. The touch driver 110 is connected to the first to p-th sensing electrodes RX1 to RXp through the first sensing line RXL1, the second sensing line RXL2, . . . , the p-2-th sensing line RXL(p-2), the p-1-th sensing line RXL(p-1), and the p-th sensing line RXLp.

The touch driver 110 may detect sensing signals from the first to p-th sensing electrodes RX1 to RXp through the first to p-th sensing lines RXL1 to RXLp while applying the driving signals to the first to q-th driving electrodes TX1 to TXq through the first to q-th driving lines TXL1 to TXLq. The touch driver 110 may detect a change in mutual capacitance based on the sensing signals.

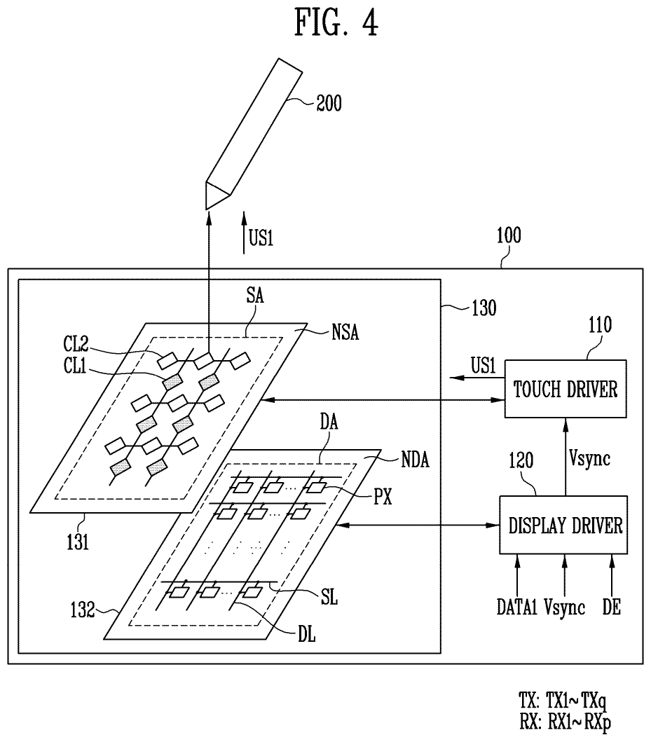

The display device 100 of FIG. 1 may exchange signals with a pen 200 (see FIG. 4) through the driving electrodes TX and the sensing electrodes RX. Hereinafter, the pen 200 may be a digital pen (or an active pen).

The touch driver 110 may supply an uplink signal US1 (see FIG. 4) to the driving electrodes TX and the sensing electrodes RX. In addition, the pen 200 may receive the uplink signal US1 (see FIG. 4) when it is adjacent to the driving electrodes TX and the sensing electrodes RX. The uplink signal US1 may include a report-rate-setting value of the pen 200, a vertical synchronization signal Vsync (see FIG. 4), and the like. The uplink signal US1 may be generated by the touch driver 110.

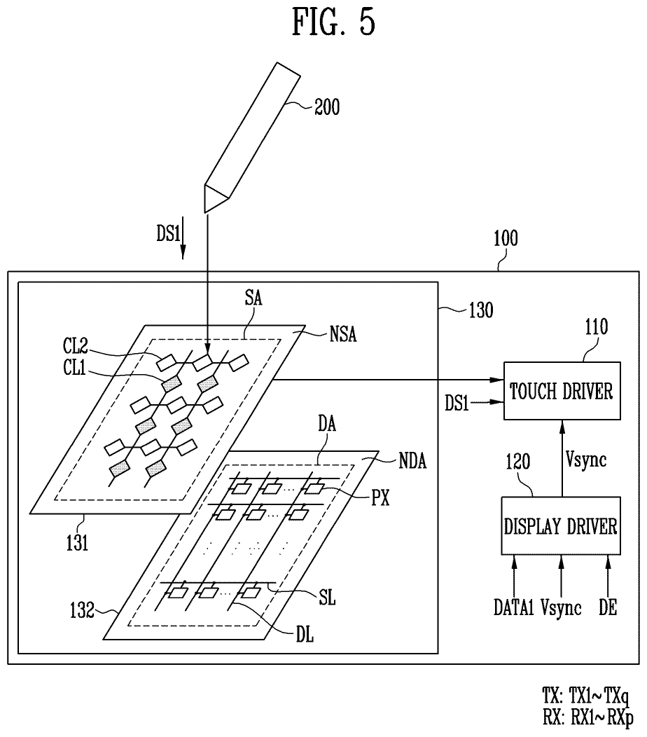

The touch driver 110 may receive a downlink signal DS1 (see FIG. 5) from the pen 200 through the driving electrodes TX and the sensing electrodes RX. The downlink signal DS1 may include at least one of position information of the pen 200, inclination information of the pen 200, and touch pressure information of the pen 200. The downlink signal DS1 may be generated by the pen 200.

In embodiments of the present disclosure, when a touch of the pen 200 is provided to the touch panel 131, the display device 100 may recognize the touch as follows.

As the pen 200 contacts or approaches the driving electrodes TX, an electric field may be generated between the pen 200 and the driving electrodes TX. Similarly, as the pen 200 contacts or approaches the sensing electrodes RX, an electric field may be generated between the pen 200 and the sensing electrodes RX. As the electric field is formed, a virtual capacitance may be formed between the pen 200 and the driving electrodes TX. In addition, a virtual capacitance may be formed between the pen 200 and the sensing electrodes RX.

The impedance of the virtual capacitance may decrease as the pen 200 approaches the driving electrodes TX and the sensing electrodes RX. The smaller the impedance of the virtual capacitance, the more advantageous or effective the transmission of the uplink signal US1 from the driving electrodes TX and the sensing electrodes RX to the pen 200. In addition, the smaller the impedance of the virtual capacitance, the more advantageous or effective the transmission of the downlink signal DS1 from the pen 200 to the driving electrodes TX and the sensing electrodes RX.

For example, the pen 200 may receive the uplink signal US1 from an adjacent driving electrode among the first to q-th driving electrodes TX1 to TXq, and the uplink signal US1 from an adjacent sensing electrode among the first to p-th sensing electrodes RX1 to RXp. In addition, the pen 200 may transmit the downlink signal DS1 to an adjacent driving electrode among the first to q-th driving electrodes TX1 to TXq, and the downlink signal DS1 to an adjacent sensing electrode among the first to p-th sensing electrodes RX1 to RXp.

The downlink signal DS1 may include position information of the pen 200 generated by the pen 200. The driving electrode TX and the sensing electrode RX receiving the downlink signal DS1 may transmit the downlink signal DS1 to the touch driver 110. The touch driver 110 may calculate the position coordinates of the pen 200 using position information included in the downlink signal DS1.

The frequency (or speed) at which the touch driver 110 calculates the position coordinates of the pen 200 may be defined as a report rate value of the touch panel 131. For example, when the report rate value of the touch panel 131 is 240 Hz, the touch driver 110 may calculate 240 pen position coordinates per second.

In addition, the frequency (or speed) at which the pen 200 transmits position information of the pen 200 to the touch driver 110 may be defined as a report rate value of the pen 200. For example, when the report rate value of the pen 200 is 240 Hz, the pen 200 may transmit position information 240 times per second. As the report rate value of the pen 200 increases, the frequency (or speed) at which the pen 200 transmits position information of the pen 200 to the touch driver 110 may become faster. Accordingly, the number of position information received by the touch driver 110 from the pen 200 per second may increase.

It is assumed that the report rate value of the pen 200 is constant. When the report rate value of the touch panel 131 increases, the frequency of calculating the position coordinates of the pen 200 of the touch driver 110 may increase. In this case, as the report rate value of the touch panel 131 increases, the ratio of the number of position coordinates calculated to the number of position information (e.g., a number of data points) of the pen 200 received by the touch driver 110 may increase.

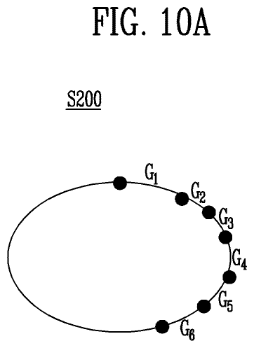

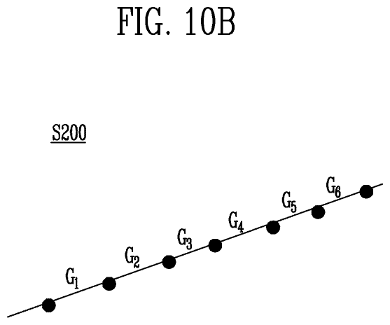

The touch driver 110 may determine whether a drawing line connecting the position coordinates corresponds to a curved line based on the calculated position coordinates of the pen 200. The display device 100 may operate in a curved line mode when the drawing line corresponds to a curved line, and may operate in a straight line mode when the drawing line corresponds to a straight line. A method of determining, by the touch driver 110, whether the drawing line is curved or straight line will be described in detail with reference to FIGS. 10A and 10B.

In the straight line mode, the touch driver 110 may fix the report rate value of the touch panel 131 to an initial set value. On the other hand, in one or more embodiments, in the curved line mode, the report rate value of the pen 200 may be fixed, and the report rate value of the touch panel 131 may be varied. In one or more other embodiments, in the curved line mode, the report rate value of the touch panel 131 may be fixed, and the report rate value of the pen 200 may be varied.

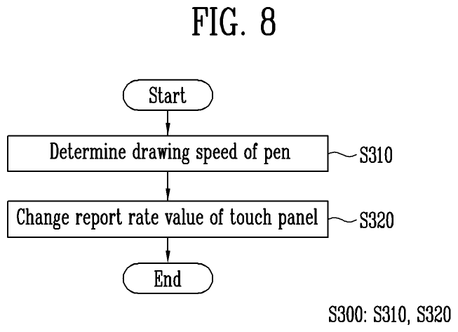

In one or more embodiments, the touch driver 110 may change the report rate value of the touch panel 131 in consideration of the drawing speed of the pen 200 in the curved line mode. As the drawing speed of the pen 200 increases, the report rate value of the touch panel 131 may increase. This will be described with reference to FIG. 8.

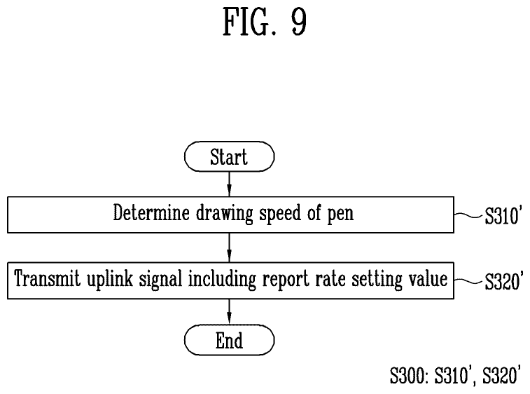

In one or more other embodiments, the touch driver 110 may change the report rate value of the pen 200 in the curved line mode. As the drawing speed of the pen 200 increases, the report rate value of the pen 200 may increase. This will be described with reference to FIG. 9.

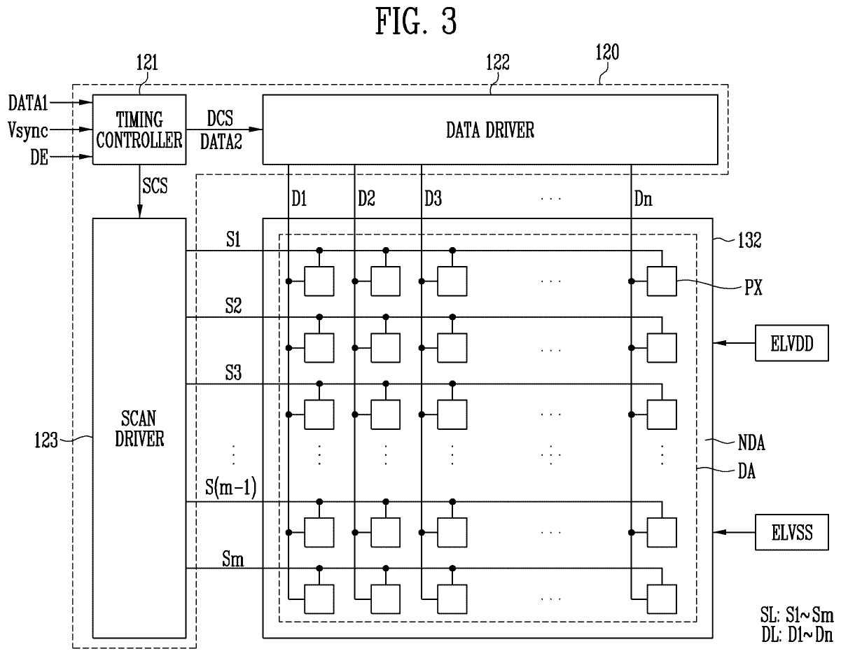

FIG. 3 illustrates a block diagram of one or more embodiments of a display driver and a display panel of FIG. 1.

Referring to FIG. 3, a display device 100 (see FIG. 1) according to one or more embodiments of the present disclosure may include a display panel 132 and a display driver 120.

The display panel 132 may include pixels PX, and data lines DL and scan lines SL connected to the pixels PX. The data lines DL may include first to n-th data lines D1 to Dn (where n is an integer equal to or greater than 1). The scan lines SL may include first to m-th scan lines S1 to Sm (where m is an integer equal to or greater than 1).

Each of the pixels PX may be connected to a first power source ELVDD and a second power source ELVSS. The pixels PX may include a light-emitting element (for example, an organic light-emitting diode), and may generate light of luminance corresponding to a data signal by a current flowing from the first power source ELVDD to the second power source ELVSS via the light-emitting element. The voltage of the first power source ELVDD may be a high-potential voltage, and the voltage of the second power source ELVSS may be a low-potential voltage.

The display driver 120 may include a scan driver 123, a data driver 122, and a timing controller 121.

The scan driver 123 may supply scan signals to first to m-th scan lines S1 to Sm in response to a scan-driving control signal SCS. For example, the scan driver 123 may sequentially supply the scan signals to the first scan line S1, the second scan line S2, the third scan line S3, . . . , the m-1-th scan line S(m-1), and the m-th scan line Sm.

For connection with the first to m-th scan lines S1 to Sm, the scan driver 123 may be directly mounted on the substrate on which the pixels PX are formed, or may be connected to the substrate through a separate component, such as a flexible circuit board.

The data driver 122 may receive a data-driving control signal DCS and second image data DATA2 from the timing controller 121 to generate a data signal. The data driver 122 may supply the generated data signal to the first data line D1, the second data line D2, the third data line D3, . . . , and the n-th data line Dn. For connection with the first to n-th data lines D1 to Dn, the data driver 122 may be directly mounted on the substrate on which the pixels PX are formed, or may be connected to the substrate through a separate component, such as a flexible circuit board.

When a scan signal is supplied to a corresponding scan line, some of the pixels PX connected to the corresponding scan line may receive a data signal transmitted from the first to n-th data lines D1 to Dn, and some of the pixels PX may emit light with a luminance corresponding to the received data signal.

The timing controller 121 may generate control signals for controlling the scan driver 123 and the data driver 122. For example, the control signals may include a scan-driving control signal SCS for controlling the scan driver 123, and a data-driving control signal DCS for controlling the data driver 122.

The timing controller 121 may generate a scan-driving control signal SCS and a data-driving control signal DCS by using an external input signal. For example, the external input signal may include a data enable signal DE and a vertical synchronization signal Vsync. In addition, the timing controller 121 may supply the scan-driving control signal SCS to the scan driver 123, and may supply the data-driving control signal DCS to the data driver 122.

The timing controller 121 may convert the first image data DATA1 input from the outside into the second image data DATA2 that meets the specifications of the data driver 122 to supply the second image data DATA2 to the data driver 122. The second image data DATA2 may include luminance information of each of the pixels PX of the display panel 132, and the second image data DATA2 may be divided into frame units.

The data enable signal DE may be a signal defining a period during which valid data is input.

Although FIG. 3 individually illustrates the scan driver 123, the data driver 122, and the timing controller 121, at least some of the components may be integrated as suitable.

An electrode to which a voltage and/or signal for driving the display panel 132 is supplied may be referred to as a panel electrode. The panel electrode may be the data lines DL, the scan lines SL, the first power source ELVDD, the second power source ELVSS, or the like. A driving voltage may be supplied to the panel electrode. For example, a data voltage may be supplied to the data lines DL, and a scan voltage may be supplied to the scan lines SL.

FIG. 4 illustrates a block diagram of an uplink process according to embodiments.

Referring to FIG. 2 and FIG. 4, the display device 100 may include the touch driver 110, the display driver 120, and the panel 130. The panel 130 may include the touch panel 131 and the display panel 132. The touch panel 131 may include the sensing electrodes RX and the driving electrodes TX. The driving electrodes TX may include the first to q-th driving electrodes TX1 to TXq. The sensing electrodes RX may include the first to p-th sensing electrodes RX1 to RXp.

The touch driver 110 may transmit the uplink signal US1 to the pen 200 through a touch electrode. In embodiments, the uplink signal US1 may include information, such as a report-rate-setting value of the pen 200, vertical synchronization signal Vsync information, panel information, and a protocol version. The pen 200 may obtain information on the vertical synchronization signal Vsync from the uplink signal US1, and accordingly, may determine the transmission time point of the downlink signal DS1. In addition, the pen 200 may check the information of the panel 130 or the version of the protocol from the uplink signal US1.

In embodiments, the display driver 120 may periodically transmit the vertical synchronization signal Vsync and/or information on the vertical synchronization signal Vsync to the touch driver 110. The touch driver 110 may output the uplink signal US1 through the driving electrodes TX and the sensing electrodes RX with reference to the vertical synchronization signal Vsync.

As the pen 200 contacts or approaches the driving electrodes TX, an electric field may be generated between the pen 200 and the driving electrodes TX. Similarly, as the pen 200 contacts or approaches the sensing electrodes RX, an electric field may be generated between the pen 200 and the sensing electrodes RX. As the electric field is formed, a virtual capacitance may be formed between the pen 200 and the driving electrodes TX. In addition, a virtual capacitance may be formed between the pen 200 and the sensing electrodes RX.

The impedance of the virtual capacitance may decrease as the pen 200 approaches the driving electrodes TX and the sensing electrodes RX. The smaller the impedance of the virtual capacitance, the more advantageous or suitable the transmission of the uplink signal US1 from the driving electrodes TX and the sensing electrodes RX to the pen 200.

For example, the pen 200 may receive the uplink signal US1 from an adjacent driving electrode among the first to q-th driving electrodes TX1 to TXq, and the uplink signal US1 from an adjacent sensing electrode among the first to p-th sensing electrodes RX1 to RXp.

In one or more other embodiments, the pen 200 may read the report-rate-setting value of the pen 200 included in the uplink signal US1. In addition, the pen 200 may change the report rate value of the pen 200 with the report-rate-setting value of the pen 200.

FIG. 5 illustrates a block diagram of a downlink process according to embodiments.

Referring to FIG. 2 and FIG. 5, the display device 100 may include the touch driver 110, the display driver 120, and the panel 130. The panel 130 may include the touch panel 131 and the display panel 132. The touch panel 131 may include the sensing electrodes RX and the driving electrodes TX. The driving electrodes TX may include the first to q-th driving electrodes TX1 to TXq. The sensing electrodes RX may include the first to p-th sensing electrodes RX1 to RXp.

The touch driver 110 may receive the downlink signal DS1 from the pen 200 through the driving electrodes TX and the sensing electrodes RX. The downlink signal DS1 may include at least one of position information of the pen 200, inclination information of the pen 200, and touch pressure information of the pen 200. The downlink signal DS1 may be generated by the pen 200.

As the pen 200 contacts or approaches the driving electrodes TX, an electric field may be generated between the pen 200 and the driving electrodes TX. Similarly, as the pen 200 contacts or approaches the sensing electrodes RX, an electric field may be generated between the pen 200 and the sensing electrodes RX. As the electric field is formed, a virtual capacitance may be formed between the pen 200 and the driving electrodes TX. In addition, a virtual capacitance may be formed between the pen 200 and the sensing electrodes RX.

The impedance of the virtual capacitance may decrease as the pen 200 approaches the driving electrodes TX and the sensing electrodes RX. The smaller the impedance of the virtual capacitance, the more advantageous or suitable the transmission of the downlink signal DS1 from the pen 200 to the driving electrodes TX and the sensing electrodes RX.

For example, the pen 200 may transmit the downlink signal DS1 to an adjacent driving electrode among the first to q-th driving electrodes TX1 to TXq, and may transmit the downlink signal DS1 to an adjacent sensing electrode among the first to p-th sensing electrodes RX1 to RXp.

The downlink signal DS1 may include position information of the pen 200, which is generated by the pen 200. The driving electrode TX and the sensing electrode RX receiving the downlink signal DS1 may transmit the downlink signal DS1 to the touch driver 110. The touch driver 110 may calculate the position coordinates of the pen 200 using position information included in the downlink signal DS1.

In one or more embodiments, when the report rate value of the touch panel 131 is changed, the frequency at which the touch driver 110 calculates position coordinates may be changed. For example, when the report rate value of the touch panel 131 increases, the frequency of calculating the position coordinates of the pen 200 of the touch driver 110 may increase.

In one or more other embodiments, when the report rate value of the pen 200 is changed, the transmission frequency of the downlink signal DS1 from the pen 200 to the driving electrodes TX and the sensing electrodes RX may be changed. For example, as the report rate value of the pen 200 increases, the transmission frequency of the downlink signal DS1 from the pen 200 to the driving electrodes TX and the sensing electrodes RX may increase.

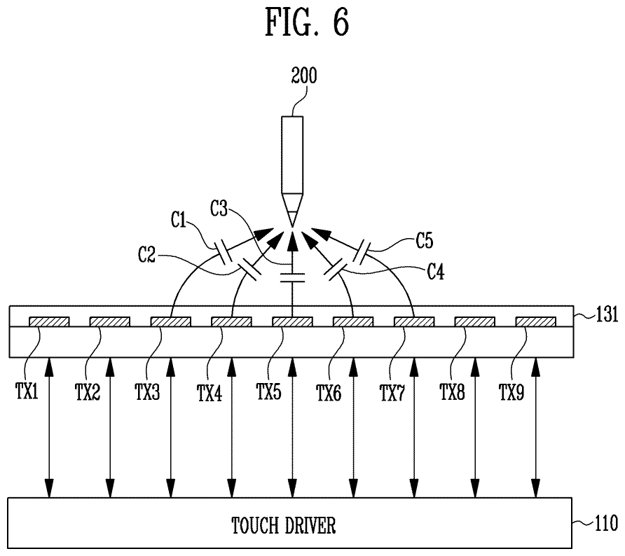

FIG. 6 is a drawing for explaining uplink signals and downlink signals.

Referring to FIG. 6, further referring to FIGS. 4 and 5, an operation in which the pen 200 receives uplink signals US1 through capacitors generated between the pen 200 and the driving electrodes TX and the sensing electrodes RX, which are adjacent to the pen 200, may be described. In addition, an operation may be described in which the pen 200 transmits downlink signals DS1 through capacitors generated between the pen 200 and the driving electrodes TX and the sensing electrodes RX that are adjacent to the pen 200.

As shown in FIG. 6, the touch driver 110 may apply the uplink signals US1 to the first driving electrode TX1, the second driving electrode TX2, the third driving electrode TX3, the fourth driving electrode TX4, the fifth driving electrode TX5, the sixth driving electrode TX6, the seventh driving electrode TX7, the eighth driving electrode TX8, and the ninth driving electrode TX9 of the touch panel 131, respectively. In addition, when the pen 200 is adjacent to the third to seventh driving electrodes TX3 to TX7 of the touch panel 131, capacitors C1, C2, C3, C4, and C5 may be formed. The pen 200 may receive the uplink signals US1 from the touch panel 131 through the capacitors C1 to C5.

Similarly, the pen 200 may generate the downlink signals DS1. When the pen 200 is adjacent to the third to seventh driving electrodes TX3 to TX7 of the touch panel 131, the capacitors C1 to C5 may be formed. The touch panel 131 may receive the downlink signals DS1 from the pen 200 through the capacitors C1 to C5. In addition, the touch driver 110 may receive the downlink signals DS1 from the touch panel 131.

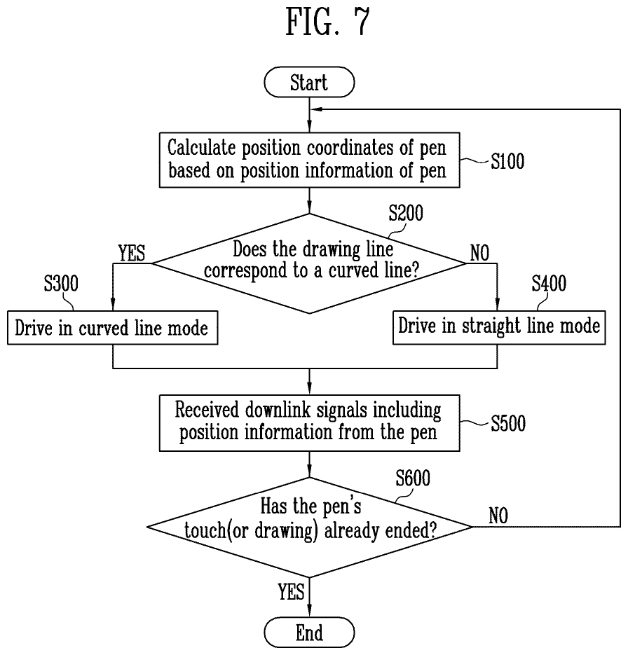

FIG. 7 illustrates a flowchart of a driving method of the display device of FIG. 1 according to embodiments.

Referring to FIG. 1 to FIG. 7, first, the touch driver 110 may perform operation S100 of calculating the position coordinates of the pen 200 based on the position information of the pen 200. For example, when drawing using the user's pen 200 starts, the touch driver 110 may first perform the calculation of the position coordinates of the pen 200 at least three times. At least three or more calculations of position coordinates may be performed so that the touch driver 110 may determine whether the drawing line connecting the position coordinates corresponds to a curved line.

The touch driver 110 may perform operation S200 of determining whether the drawing line corresponds to a curved line. This will be described with reference to FIG. 10A and FIG. 10B.

When the drawing line corresponds to a curved line, the touch driver 110 may perform operation S300 of driving in a curved line mode. In addition, when the drawing line corresponds to a straight line, the touch driver 110 may perform operation S400 of driving in a straight line mode.

The touch driver 110 may perform operation S500 of receiving the downlink signals DS1 including position information from the pen 200. In this case, the frequency (or speed) at which the pen 200 transmits the downlink signals DS1 to the touch driver 110 may be determined according to the report rate value of the pen 200. As the report rate value of the pen 200 increases, the frequency at which the downlink signals DS1 are transmitted may increase.

The touch driver 110 may perform operation S600 of determining whether the touch (or drawing) of the pen 200 has ended. For example, when the pen 200 is adjacent to the touch panel 131, the pen 200 may transmit the downlink signals DS1 to the touch panel 131. Accordingly, when the touch (or drawing) of the pen 200 has ended, the touch panel 131 may not be able to receive the downlink signals DS1. It may be determined whether the touch (or drawing) of the pen 200 has ended based on whether the downlink signals DS1 of the touch panel 131 are received.

When the touch of the pen 200 has not ended, the touch driver 110 May perform operation S100 of calculating the position coordinates of the pen 200 based on the received position information. Then, operation S200 to operation S600 may be repeated.

FIG. 8 illustrates a flowchart of operation S300 of FIG. 7 according to one or more embodiments.

Referring to FIGS. 1 to 8, when the touch driver 110 operates in a curved line mode, operation S310 of determining the drawing speed of the pen 200 may be performed first.

In addition, the touch driver 110 may perform operation S320 of changing the report rate value of the touch panel 131 by considering the drawing speed. For example, when the drawing speed increases, the touch driver 110 may increase the report rate value of the touch panel 131.

The report rate value of the touch panel 131 in the straight line mode may be greater than the report rate value of the touch panel 131 in the curved line mode for the same drawing speed.

FIG. 9 illustrates a flowchart of operation S300 of FIG. 7 according to one or more other embodiments.

Referring to FIGS. 1 to 9, when the touch driver 110 operates in a curved line mode, operation S310′ of determining the drawing speed of the pen 200 may be performed first. In addition, the touch driver 110 may determine the report-rate-setting value by considering the drawing speed. For example, when the drawing speed increases, the report-rate-setting value may be increased.

Next, the touch driver 110 may perform operation S320′ of transmitting the uplink signal US1 including the report-rate-setting value to the pen 200 through the driving electrodes TX and the sensing electrodes RX. The pen 200 receiving the uplink signal US1 may set the report-rate-setting value as the report rate value of the pen 200.

The report rate value of the pen 200 in the straight line mode may be greater than the report rate value of the pen 200 in the curved line mode for the same drawing speed.

FIG. 10A and FIG. 10B are drawings for explaining operation S200 of FIG. 7.

Referring to FIG. 10A and FIG. 10B, further referring to FIG. 6, respective points may correspond to touch position coordinates of the pen 200 calculated by the touch driver 110.

In addition, the touch driver 110 may calculate inclination values of lines (or drawing lines) connecting adjacent points. For example, the touch driver 110 may calculate the first inclination value G1, the second inclination value G2, the third inclination value G3, the fourth inclination value G4, the fifth inclination value G5, and the sixth inclination value G6 through seven points.

When the drawing line is a curved line, as shown in FIG. 10A, the changes in the first to sixth inclination values G1 to G6 may be large. The touch driver 110 may determine that the drawing line corresponds to a curved line based on the amount of change in inclination values.

On the other hand, when the drawing line is a straight line as shown in FIG. 10B, the change in the first to sixth inclination values G1 to G6 may be zero or relatively very small. The touch driver 110 may determine that the drawing line corresponds to a straight line based on the amount of change in inclination values.

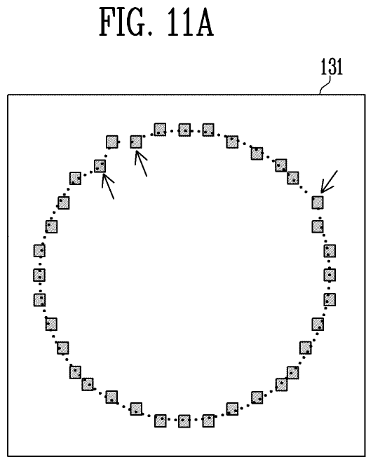

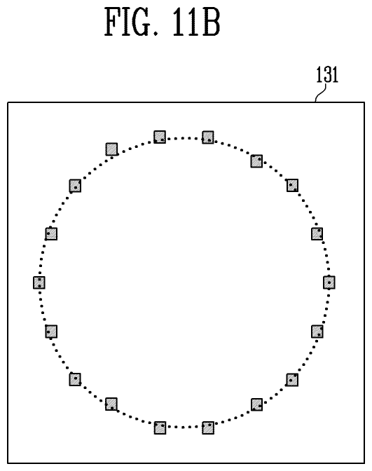

FIG. 11A and FIG. 11B are drawings for explaining aspects of a display device according to embodiments.

Referring to FIG. 11A and FIG. 11B, further referring to FIGS. 1 and 6, the results of the touch driver 110 calculating the touch position coordinates of the pen 200 on the touch panel 131 are shown.

FIG. 11A shows the result of the touch driver 110 setting and calculating the report rate value of the touch panel 131 or the report rate value of the pen 200 to 240 Hz. On the other hand, FIG. 11B shows the result of the touch driver 110 setting and calculating the report rate value of the touch panel 131 or the report rate value of the pen 200 to 120 Hz.

The drawing line may not be cleanly drawn due to the user's hand shaking or other external environments, and the drawing line may be drawn with shaking (see an arrow in FIG. 11A) that the user does not want.

For example, as the display device 100 becomes larger, the shaking of the drawing line may be more easily visually recognized as the distance between the driving electrodes TX and the sensing electrodes RX increases. In addition, when the drawing line is a curved line, the shaking of the drawing line may be more easily visually recognized. In other words, the expression quality of the curved drawing line may deteriorate.

The touch driver 110 according to one or more embodiments of the present disclosure may lower the report rate value of the touch panel 131 in the curved line mode compared to in the straight line mode. In addition, the touch driver 110 according to one or more other embodiments of the present disclosure may lower the report rate value of the pen 200 in the curved line mode compared to in the straight line mode.

As shown in FIG. 11B, because the touch driver 110 expresses the drawing line based on fewer position coordinates, indication of undesired shaking may be efficiently eliminated. In addition, the expression quality of the curved drawing line may be improved.

A display device 100 according to an embodiment is applicable to various types of electronic devices. In an embodiment, an electronic device includes the above-described display device 100 and may further include other modules or devices having additional functions in addition to the display device 100.

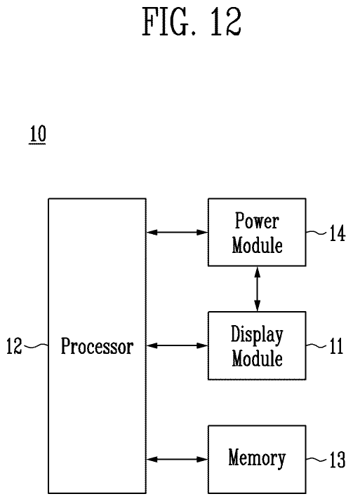

FIG. 12 is a block diagram of an electronic device according to an embodiment. Referring to FIG. 12, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

The memory 13 may store data and/or information used to operate the processor 12 or the display module 11. When the processor 12 executes an application stored in the memory 13, image data signals and/or input control signals may be transferred to the display module 11. The display module 11 may process the provided signals and output image information in a display screen.

The power module 14 may include a power supply module, such as a power adapter or a battery device, and a power conversion module. The power conversion module converts power supplied by the power supply module and generates power to operate the electronic device 10.

At least one of the above-described components of the electronic device 10 may be included in the display device 100 according to embodiments as described above. In addition, in terms of functionality, some of the individual modules included in one module may be included in the display device 100 and others may be provided separately from the display device. For example, the display module 11 is included in the display device 100, whereas the processor 12, the memory 13, and the power module 14 are not included in the display device 100 and are instead provided separately in the electronic device 10.

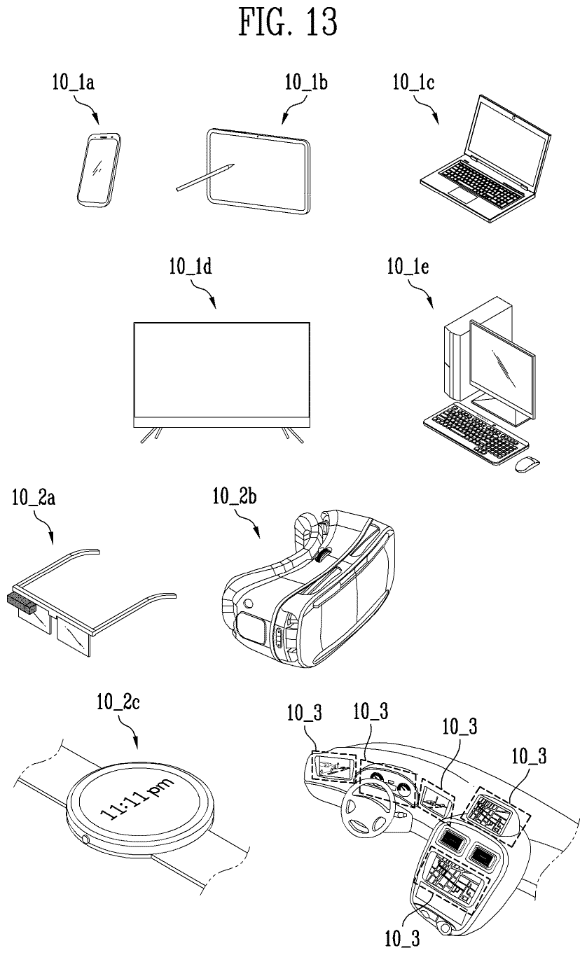

FIG. 13 shows schematic views of various embodiments of an electronic device.

Referring to FIG. 13, various types of electronic devices to which embodiments of a display device are applied may include an electronic device to display images such as a smartphone 10_1a, a tablet PC 10_1b, a laptop computer 10_1c, a television (TV) 10_1d, and a desktop monitor 10_1e, a wearable electronic device including a display module such as smart glasses 10_2a, a head-mounted display (HMD) 10_2b, and a smart watch 10_2c, and an automotive electronic device 10_3 including a display module such as a center information display (CID) disposed at the instrument cluster, the center fascia, and the dashboard of a vehicle, and a room mirror display.

Although certain embodiments and implementations have been described herein, other embodiments and modifications will be apparent from this description. Accordingly, the present disclosure is not limited to the embodiments, but rather to the broader scope of the presented claims and various obvious modifications and equivalent arrangements.

What is claimed is:

1. A driving method of a display device comprising a touch panel, wherein the driving method comprises:
receiving position information of a pen adjacent to the touch panel;
calculating a plurality of position coordinates of the pen;
determining whether a drawing line connecting the plurality of position coordinates corresponds to a curved line based on the plurality of position coordinates of the pen;
driving in a curved line mode when the drawing line corresponds to the curved line, or driving in a straight line mode when the drawing line does not correspond to the curved line; and
changing a report rate value of the touch panel by considering a drawing speed of the pen in the curved line mode.

2. The driving method of claim 1, wherein the driving method further comprises increasing the report rate value as the drawing speed of the pen increases in the curved line mode.

3. The driving method of claim 1, wherein the report rate value in the straight line mode is greater than the report rate value in the curved line mode for the same drawing speed.

4. The driving method of claim 1, wherein as the report rate value decreases, a ratio of a number of the plurality of position coordinates calculated to a number of the position information received decreases.

5. The driving method of claim 1, wherein the driving method further comprises fixing the report rate value to an initial set value in the driving in the straight line mode.

6. The driving method of claim 1, wherein the determining whether the drawing line corresponds to the curved line comprises:
calculating a plurality of inclination values between the plurality of position coordinates of the pen; and
determining whether the drawing line corresponds to the curved line by using an amount of change in the plurality of inclination values.

7. The driving method of claim 1, wherein the driving method further comprises receiving, at the display device, from the pen, a downlink signal comprising at least one of the position information and at least one of inclination information of the pen and touch pressure information of the pen.

8. A driving method of a display device comprising a touch panel, wherein the driving method comprises:
receiving position information of a pen adjacent to the touch panel;
calculating a plurality of position coordinates of the pen;
determining whether a drawing line connecting the plurality of position coordinates corresponds to a curved line based on the plurality of position coordinates of the pen;
driving in a curved line mode when the drawing line corresponds to the curved line, or driving in a straight line mode when the drawing line does not correspond to the curved line; and
changing a report rate value of the pen by considering a drawing speed of the pen in the curved line mode.

9. The driving method of claim 8, wherein the driving in the curved line mode comprises:
transmitting, by the display device, an uplink signal comprising a report-rate-setting value to the pen; and
changing the report rate value of the pen to the report-rate-setting value.

10. The driving method of claim 8, wherein the driving method further comprises increasing the report rate value of the pen as the drawing speed of the pen increases in the driving in the curved line mode.

11. The driving method of claim 8, wherein the report rate value in the straight line mode is greater than the report rate value in the curved line mode for the same drawing speed.

12. The driving method of claim 8, wherein the driving method further comprises decreasing a number of the position information received from the pen as the report rate value of the pen decreases.

13. The driving method of claim 8, wherein the driving method further comprises fixing the report rate value of the pen to an initial set value in the driving in the straight line mode.

14. The driving method of claim 8, wherein the determining whether the drawing line corresponds to the curved line comprises:
calculating a plurality of inclination values between the plurality of position coordinates of the pen; and
determining whether the drawing line corresponds to the curved line by using an amount of change in the plurality of inclination values.

15. The driving method of claim 8, wherein the driving method further comprises receiving, at the display device, from the pen, a downlink signal comprising at least one of the position information, and at least one of inclination information of the pen and touch pressure information of the pen.

16. An electronic device comprising a display device, wherein the display device comprises:
a touch panel comprising touch electrodes; and
a touch driver configured to:
receive position information of a pen adjacent to the touch panel;
calculate a plurality of position coordinates of the pen;
determine whether a drawing line connecting the plurality of position coordinates corresponds to a curved line based on the plurality of position coordinates of the pen;
drive in a curved line mode when the drawing line corresponds to the curved line, or drive in a straight line mode when the drawing line does not correspond to the curved line; and
change a report rate value of the touch panel by considering a drawing speed of the pen in the curved line mode.

17. The electronic device of claim 16, wherein the report rate value is configured to increase as the drawing speed of the pen increases in the curved line mode.

18. The electronic device of claim 16, wherein the report rate value in the straight line mode is greater than the report rate value in the curved line mode for the same drawing speed.

19. The electronic device of claim 16, wherein the electronic device comprises a smartphone, a television, a monitor, a tablet, an electric vehicle, a mobile phone, a tablet personal computer, a mobile communication terminal, an electronic notebook, an electronic book, a portable multimedia player, a navigation device, an ultra-mobile personal computer, a laptop computer, a billboard, an Internet of Things device, a smartwatch, a watch phone, or a head-mounted display.
